(19) United States
(12) Patent Application Publication
(10) Pub. No.: US 2018/0341987 A1
(43) Pub. Date: Nov. 29, 2018

(54) Device, System, and Method for a Social Fit Assessment

(71) Applicant: Viacom International Inc., NEW YORK, NY (US)

(72) Inventors: Sashi MARELLA, New York, NY (US); Tanmay MANOHAR, New York, NY (US); David BERZIN, New York, NY (US)

(21) Appl. No.: 15/604,430

(22) Filed: May 24, 2017

(51) Int. Cl. G06Q 30/02; G06Q 50/00

(52) U.S. Cl. CPC G06Q 30/0269; G06Q 50/01

(57) ABSTRACT

A device, system, and method determines a social fit assessment. The method performed on a fit server includes receiving a request including identities of first and second entities involved in a collaborative campaign. The method includes generating first and second profiles for the first second entities, the first and second profiles based on first and second audiences associated with the first and second entities. The method includes determining a third entity to be cooperatively involved in the collaborative campaign. The method includes generating a third profile for the third entity, the third profile based on a third audience associated with the third entity. The method includes determining a similarity index for the third entity with the first and second entities based on the first, second, and third profiles, the similarity index indicating the social fit of the third entity with the first and second entities.

### BACKGROUND INFORMATION

Media content creation and distribution may involve a variety of different entities. For example, the media content may be a television program. For a television program, a producer producing the program and/or a distributor distributing the program may be a first entity. An advertiser that includes advertisements in the program or that sponsors the program may be a second entity. In another example, the media content may be an online media program. The online media program may similarly include entities such as the producer, distributor, and advertiser. Another type of entity that may be involved is a social talent such as a person who has a minimum social popularity or influence. In a particular example, the social talent may be a creator of the material for the online media program or an online personality who references or speaks about the online media program.

To optimize the benefits for both the producer/distributor and the advertiser, an affinity model may be used to determine whether a collaboration between these entities results in desired effects by analyzing audiences of the entities. For example, a distributor who retains an advertiser as a sponsor may receive financial gains from the advertiser to air the television program. The television program may have an intended audience such that the advertiser that sponsors the television program may then reach this audience in the expectation that members of the audience purchase a product of the advertiser.

The affinity model may provide invaluable information about a particular audience. For example, the affinity model may indicate what a particular audience is also following to determine a sense for this particular audience associated with a given entity. Accordingly, the affinity model may be used to determine information between only two entities and draw a direct comparison that leads to a social affinity determination for these two entities. However, with the addition of one or more entities to consider, the affinity model is not capable of being used to directly correlate how close or an affinity between a plurality of entities. Instead, a symmetric metric must be determined that obeys the triangle-inequality to define distances between entities that also take into account all the various dimensions that the entities (e.g., an advertiser) use to consider a certain entity (e.g., an associated cost of using this entity). Without this metric, the affinity models alone may not be capable of being used to measure multi-entity closeness.

In determining this metric, access to first party social network data may be required. However, those skilled in the art will understand that this data may be proprietary, costly to attain, or unavailable. Accordingly, determining the affinity between entities may not be possible. For example, with multiple entities, beyond the distributor and the advertiser, the campaign may involve a social talent. However, the affinity model does not consider a third entity and may not be used to identify a social talent who may be involved in the campaign to further reach a greater audience while still considering both the distributor and the advertiser. That is, drawing a conclusion of an affinity between two entities through the affinity models (e.g., between a first entity and a second entity, between the first entity and a third entity, and between the first entity and the third entity) does not provide the proper affinity determination of three entities considered at the same time. Furthermore, even assuming a proper affinity determination may be made, any determination of an affinity between three or more entities based on affinity models that compare only two entities may be significantly inefficient and may require speculations that lead to inaccurate affinities.

### SUMMARY

The exemplary embodiments are directed to a method, comprising: in a fit server: receiving a request including an identity of a first entity and an identity of a second entity, the first and second entities cooperatively involved in a collaborative campaign; generating a first profile for the first entity and a second profile for the second entity, the first and second profiles being generated based on characteristic types of a first audience associated with the first entity and a second audience associated with the second entity, respectively; determining at least one third entity to be cooperatively involved in the collaborative campaign; generating a respective third profile for each of the at least one third entity, the third profile being generated based on the characteristic types of a third audience associated with the third entity; determining a respective similarity index for each of the at least one third entity with the first and second entities based on the first, second, and third profiles; and determining at least one of the at least one third entity to be involved in the collaborative campaign based on the similarity index.

The exemplary embodiments are directed to a fit server, comprising: a transceiver receiving a request including an identity of a first entity and an identity of a second entity, the first and second entities cooperatively involved in a collaborative campaign; and a processor generating a first profile for the first entity and a second profile for the second entity, the first and second profiles being generated based on characteristic types of a first audience associated with the first entity and a second audience associated with the second entity, respectively, the processor determining at least one third entity to be cooperatively involved in the collaborative campaign, the processor generating a respective third profile for each of the at least one third entity, the third profile being generated based on the characteristic types of a third audience associated with the third entity, the processor determining a respective similarity index for each of the at least one third entity with the first and second entities based on the first, second, and third profiles, the processor determining at least one of the at least one third entity to be involved in the collaborative campaign based on the similarity index.

The exemplary embodiments are directed to a method, comprising: in a fit server: receiving a request including an identity of a first entity and an identity of a second entity, the first and second entities cooperatively involved in a collaborative campaign; generating a first profile for the first entity and a second profile for the second entity, the first and second profiles being generated based on characteristic types of a first audience associated with the first entity and a second audience associated with the second entity, respectively; determining an overlap in the first and second profiles for the characteristic types between the first and second entities; determining at least one third entity to be cooperatively involved in the collaborative campaign, the at least one third entity including the overlap in the first and second profiles; generating a respective third profile for each of the at least one third entity, the third profile being generated based on the characteristic types of a third audience associated with the third entity; determining a respective similarity index for each of the at least one third entity with the first and second entities based on the first, second, and third profiles; and determining at least one of the at least one third entity to be involved in the collaborative campaign based on the similarity index.

### BRIEF DESCRIPTION OF THE DRAWINGS

FIG. 1 shows a system according to the exemplary embodiments.

FIG. 2 shows a fit server of FIG. 1 according to the exemplary embodiments.

FIG. 3 shows a method of determining a social fit across a plurality of entities according to the exemplary embodiments.

### DETAILED DESCRIPTION

The exemplary embodiments may be further understood with reference to the following description and the related appended drawings, wherein like elements are provided with the same reference numerals. The exemplary embodiments are related to a device, system, and method for determining a combination of entities across a social universe based on audiences associated with the entities and affinities of the audiences to one another in the combination. Specifically, the exemplary embodiments provide a discovery mechanism for an entity to determine at least one further entity to be combined with the entity such as in a media content campaign to, for example, reach a greatest size audience. As will be described in further detail below, the entities may include a producer, a distributor, an advertiser, a sponsor, and an influencer (e.g., a social talent).

Initially, it is noted that the producer may be an entity that creates or has ownership of media content whereas the distributor may be an entity that distributes the media content to various outlets (e.g., a licensee of the media content). The producer and the distributor may be separate entities or may be the same entity. For illustrative purposes, the producer and the distributor are referred to herein collectively as the “distributor.” It is also noted that the advertiser may be an entity that sells a product and purchases or otherwise agrees to have advertisements for the product shown during the media content. A sponsor may be an entity that provides finances to the distributor to release the media content in return for different forms of consideration (e.g., mentioned within the program, etc.). The advertiser and the sponsor may be separate entities or may be the same entity. For illustrative purposes, the advertiser and the sponsor are referred to herein collectively as the “advertiser.”

It is also noted that the exemplary embodiments are described herein with regard to distributors, advertisers, and influencers. However, this universe of entities, particularly associated with media content, is only exemplary. Those skilled in the art will understand that the exemplary embodiments may be modified and/or used with another universe of entities that may cooperate in a combination for a campaign, the combination of the entities providing mutual benefits to optimize a desired goal.

There are various affinity models that determine what an audience of an entity (e.g., an advertiser, a producer releasing a particular media content, an influencer, etc.) is also following. Accordingly, the affinity models may provide a sense of an audience for a particular entity. For example, services that utilize affinity models may pull in follower or audience graphs associated with an entity and identify other content that the audience for the entity additionally follow. However, the services utilizing the affinity models provide only an assessment of a particular audience without consideration of further factors, specifically other entities. In addition, methodologies that attempt to determine an affinity between two entities requires first party social network data which is only available to large technology companies or owners of the data. Even if available data were aggregated to be pulled from a backend source, this data is anonymized and has no context beyond the activities of a specific user (e.g., due to privacy concerns). In this manner, the aggregation of the data loses information available in the raw data about audiences that are shared by other entities.

The exemplary embodiments expand the affinity models and the analysis utilizing the affinity models. Accordingly, the exemplary embodiments utilize a plurality of assessment models to determine a sense of fit between audiences of multiple entities. For example, a distributor may be a television network (e.g., MTV) that plans to air media content (e.g., the VMAs). An advertiser (e.g., Pepsi) may have sponsored the media content. To further expose the media content to a wider audience as well as consider the advertiser, an influencer may be involved in a campaign for the media content. The exemplary embodiments are configured to identify an optimal influencer (or third entity) to become involved with the pairing of the distributor (or first entity) and the advertiser (or second entity) to benefit both the distributor and the advertiser based on the respective audiences thereof. Specifically, the exemplary embodiments use available vendor data or data that is provided by a platform in a backend application program interface (API) that is aggregated and anonymized. The exemplary embodiments may be configured to circumvent the issues of this aggregated/anonymized data by comparing entities based on a probability distribution of underlying audience characteristics. Accordingly, the exemplary embodiments take advantage of how a metric obeys certain properties like symmetry and a triangle property that may be used to cluster multiple entities together as well as select a closest neighbor to a given set of entities.

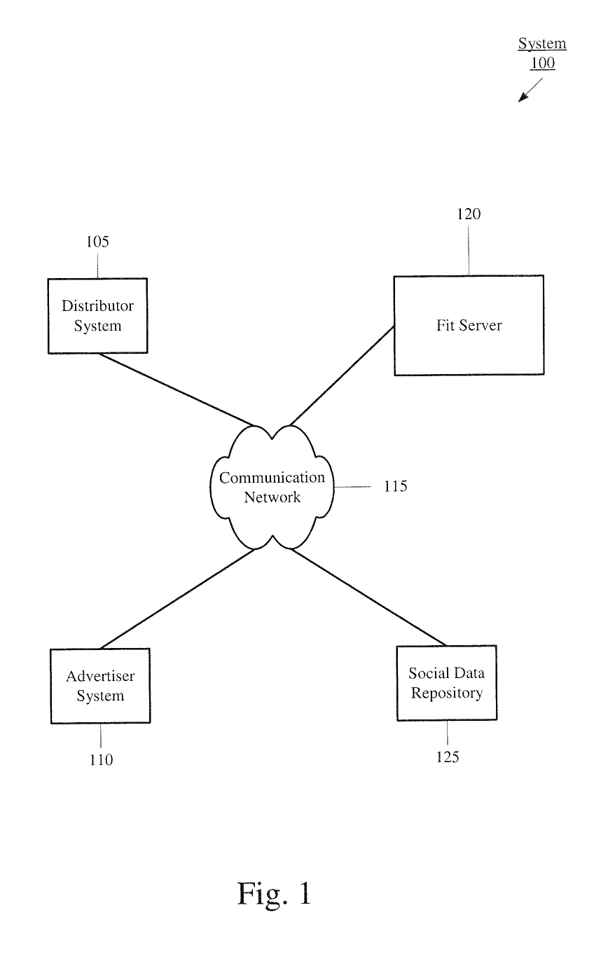

FIG. 1 shows a system 100 according to the exemplary embodiments. The system 100 may include a plurality of entities involved in a media content campaign. For example, the system 100 may include a distributor system 105 and an advertiser system 110. The system 100 may also include a fit server 120 configured to determine an optimal combination of the distributor associated with the distributor system 105 and the advertiser associated with the advertiser system 110. The distributor system 105, the advertiser system 110, and the fit server 120 may communicate via a communication network 115. The fit server 120 may determine an influencer to be included in the combination based on data received from a social data repository 125. It should be noted that the system 100 is shown with connections between the components. However, those skilled in the art will understand that these connections may be through a wired connection, a wireless connection, interactions between integrated components or software subroutines, or a combination thereof.

The distributor system 105 may include a producer and/or distributor who creates or broadcasts, respectively, media content to an audience. The distributor system 105 may be for media content broadcast using a variety of different mediums. In a first example, the distributor system 105 may broadcast media content using different distribution models (e.g., linear distribution model, a non-linear distribution model, etc.). In another example, the distributor system 105 may broadcast media content for viewing on television. In a further example, the distributor system 105 may broadcast media content in an online manner. The media content of the distributor system 105 may be pre-recorded media content, live media content, on-demand media content, etc. Those skilled in the art will understand that the distributor system 105 may include various hardware and/or software configured to provide the media content. The distributor system 105 may also include a server or other communication component to provide data to the fit server 120. In a specific example, the distributor system 105 may transmit a request for the fit server 120 to identify an influencer and/or an advertiser for an upcoming media content campaign.

The advertiser system 110 may include an advertiser who creates advertisement content that may be shown or included in a media content. The advertiser system 110 may be configured to transmit the advertisement content or sponsorship logos to be included in the media content to the distributor system 105. Those skilled in the art will understand that, like the distributor system 105, the advertiser system 110 may include various hardware and/or software configured to provide the advertisement content. The advertiser system 110 may also include a server or other communication component to provide data to the fit server 120. In a specific example, the advertiser system 110 may transmit a request for the fit server 120 to identify an influencer and/or a media content associated with a distributor for inclusion of the advertisement content in an upcoming media content campaign.

It is noted that the system 100 of FIG. 1 showing a single distributor system 105 and a single advertiser system 110 is only exemplary. Those skilled in the art will understand that there may be any number of distributor systems and advertiser systems who provide media content and advertisement content, respectively. Thus, the distributor system 105 may represent all the different sources from which media content originates or is distributed while the advertiser system 110 may represent all the different sources from which advertisement content is provided.

The communications network 115 may be any type of network that enables data to be transmitted from a first device to a second device where the devices may be a network device and/or an edge device that has established a connection to the communications network 115. For example, the communications network 115 may be a cable provider network, a satellite network, a terrestrial antenna network, the public Internet, a local area network (LAN), a wide area network (WAN), a virtual LAN (VLAN), a Wi-Fi network, a cellular network, a cloud network, a wired form of these networks, a wireless form of these networks, a combined wired/wireless form of these networks, etc. The communications network 115 may also represent one or more networks that are configured to connect to one another to enable the data to be exchanged among the components of the system 100. The communications network 115 may also include network components (not shown) that are configured to perform further functionalities in addition to providing a conduit to exchange data.

The social data repository 125 may be any source from which data associated with influencers may be received. For example, the social data repository 125 may be from a first social networking entity. The first social networking entity may track user activity, user status, user followers, follower status, social post performance metrics (e.g., reach, engagement, etc.), etc. The information from the first social networking entity may be enriched to create further metrics that are tracked. The first social networking entity may store this data in the social data repository 125. When allowed (e.g., publicly available) or an arrangement is reached (e.g., proprietary information), the data in the social data repository 125 may be requested and received by, for example, the fit server 120. A second social networking entity may also store data in the social data repository 125, from which the fit server 120 may request and receive the data associated with the second social networking entity. As will be described in detail below, the data in the social data repository 125 may be specific to a given user who may be considered an influencer or social talent who holds sway over his or her audience.

It is noted that the system 100 of FIG. 1 showing a single social data repository 125 is only exemplary. Those skilled in the art will understand that there may be any number of social data repositories for each entity (e.g., social networking entity) who stores data associated with influencers and other types of data. In fact, a single user may have a social personality as multiple users across respective multiple entities. Thus, the social data repository 125 may represent all the sources from which the social data may be requested and received.

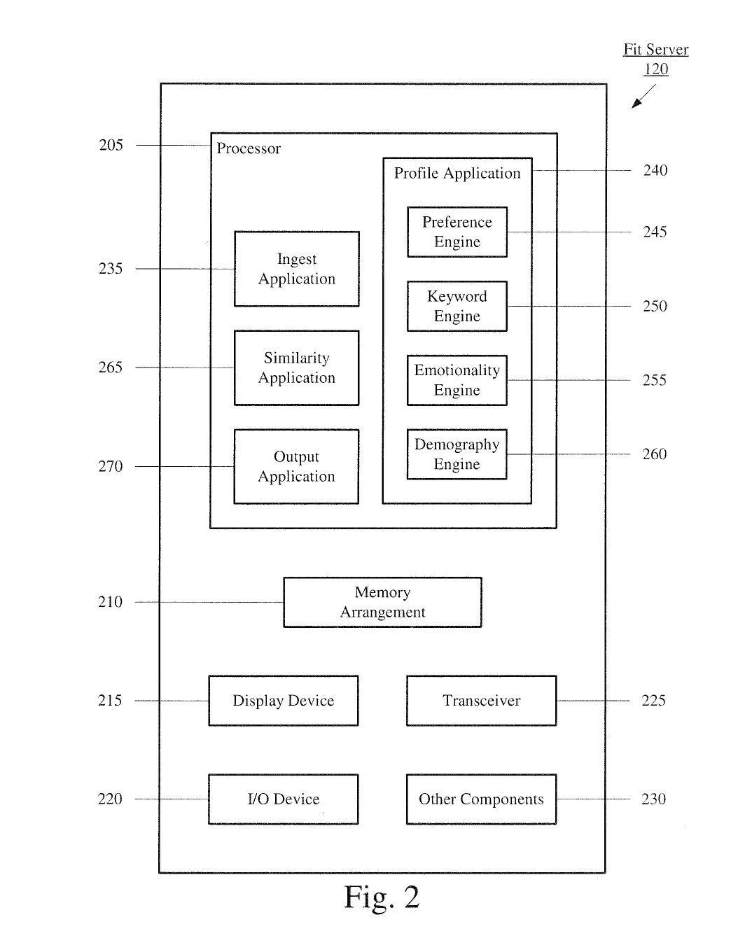

According to the exemplary embodiments, the fit server 120 may perform a variety of different operations to determine an optimal combination of distributor, advertiser and influencer for a media content campaign which mutually optimizes the benefits of the distributor and the advertiser (as well as the influencer). FIG. 2 shows the fit server 120 of FIG. 1 according to the exemplary embodiments. The fit server 120 may include a processor 205, a memory arrangement 210, a display device 215, an input/output (I/O) device 220, a transceiver 225, and other components 230 (e.g., an audio input device, an audio output device, a battery, a data acquisition device, ports to electrically connect to other electronic devices, etc.).

Initially, it is noted that the fit server 120 being shown as a separate component from the components of the system 100 is only exemplary. For example, in the system 100, the fit server 120 may provide a service as a third party and receive requests from the distributor system 105 and/or the advertiser system 110. In another example, the functionalities of the fit server 120 may be incorporated into one of the systems 105, 110. In a particular exemplary embodiment, the distributor system 105 may include the functionalities of the fit server 120. As the distributor system 105 may plan various media content campaigns, each of these campaigns may individually utilize a combination of advertiser and influencer.

The processor 205 may be configured to execute a plurality of applications of the fit server 120. For example, the processor 205 may execute an ingest application 235, a profile application 240, a similarity application 265, and an output application 270. As will be described in further detail below, the ingest application 235 may be utilized to receive requests from the distributor system 105 and/or the advertiser system 110 as well as transmit requests for data from the distributor system 105, the advertiser system 110, and/or the social data repository 125. The profile application 240 may determine attributes of a distributor (e.g., associated with the distributor system 105), an advertiser (e.g., associated with the advertiser system 110), and an influencer (e.g., based on data received from the social data repository 125). As will also be described in detail below, the profile application 240 may generate a profile of the attributes based on various considerations such as a preference (via a preference engine 245), associated keywords (via a keyword engine 250), reaction toward/against (via an emotionality engine 255), and a demography (via a demography engine 260). The similarity application 265 may utilize the profiles output from the profile application 240 and determine a fit from a combination of the distributor, the advertiser, and the influencer. The output application 270 may generate graphical representations of the various outputs from the profile application 240 and the similarity application 265.

It should be noted that the above noted applications being an application (e.g., a program) executed by the processor 205 is only exemplary. The functionality associated with the applications may also be represented as a separate incorporated component of the fit server 120 or may be a modular component coupled to the fit server 120, e.g., an integrated circuit with or without firmware. In yet another example, the functionality associated with the applications may be embodied in a multi-application service or gateway. In a particular manner, the functionalities may be a background operation such that a request for a fit combination may be input, the functionalities may be performed, and an outcome based on the results of the functionalities may be provided. Accordingly, a user may log into the service, input the request, and be provided the outcome (while the functionalities are utilized in a background capacity).

The memory arrangement 210 may be a hardware component configured to store data related to operations performed by the fit server 120. Specifically, the memory arrangement 210 may store the data from the social data repository as well as previously determined outputs from the various engines 245-260 of the profile application 240. The display device 215 may be a hardware component configured to show data to a user while the I/O device 220 may be a hardware component that enables the user to enter inputs. The transceiver 225 may be a hardware component configured to transmit and/or receive data in a wired or wireless manner. Specifically, the transceiver 225 may be used with the communications network 115.

According to the exemplary embodiments, the fit server 120 provides a discovery platform for a fit analysis across a social universe of brands associated with distributors (e.g., a media content such as a television show, an awards show, a movie, etc.), advertisers, and influencers. By blending a myriad of data sources (e.g., from the distributor, from the advertiser, from the social data repository 125, etc.), the fit server 120 leverages individual strengths and unique insights for respective audiences of the entities to determine an optimal combination (e.g., to attract the most viewers to a media content of the distributor where the viewers may also be interested in a product of the advertiser). As will be described in detail below, the fit server 120 provides a highly granular window into the social universe of brands of distributors, advertisers, and influencers. The fit server 120 may generate distance and similarity metrics and use clustering techniques to unmask natural associations that exist between audiences of distributors, advertisers, and influencers. As will be described in detail below, the fit server 120 may perform a plurality of operations to determine and provide an output of an optimal candidate to include as a combination for a media content campaign given an initial selection of at least one of a brand of a distributor, an advertiser, and an influencer. For illustrative purposes, the exemplary embodiments described herein relate to at least one of the distributor (or the brand thereof) and the advertiser being provided as a basis such that pairing between the distributor and the advertiser is used to identify the influencer. However, those skilled in the art will understand that this basis and identification is only exemplary and any two of the three entities may be known to identify the third entity.

As described above, the ingest application 235 may be utilized to receive requests from the distributor system 105 and/or the advertiser system 110. That is, the ingest application 235 may be used for an initial operation to activate the further functionalities and determine an optimal combination of distributor, advertiser, and influencer. According to an exemplary embodiment, the ingest application 235 may receive one or more initial selections in a request from a user. The user may be associated with the distributor system 105 and/or the advertiser system 110. In a first example, the request may indicate an identity of the brand of the distributor. Specifically, the brand of the distributor may be for an upcoming television broadcast. In a second example, the request may indicate an identity of an advertiser. Specifically, the advertiser may be for a particular product. In a third example, the request may indicate identities of both the brand of the distributor and the advertiser. In this manner, the request received by the ingest application 235 may include any number and any type of initial selections to be used as a basis in determining an optimal combination for a media content campaign. Accordingly, when the request includes only the brand of the distributor, the fit server 125 may determine an advertiser to be used with the brand and further determine an influencer to associate with the media content campaign. When the request includes only the advertiser, the fit server 125 may determine a brand and a distributor of the brand to associate for a media content campaign and further determine an influencer for the media content campaign. When the request includes both the brand of the distributor and the advertiser, the fit server 125 may determine an influencer for the media content campaign.

The request may also include further information. In a first example, although the identity of the brand of the distributor and/or the advertiser may enable the fit server 120 to determine characteristics associated with the identity (e.g., public and/or associated knowledge of the identity), the request may include keywords and/or other characterizing information for the fit server 120 to use. For example, the brand of the distributor may be shifting to cover or move to a different audience but the distributor may be known for other characteristics. Thus, the request may include desired characteristics for the fit server 120 to use. In a second example, the request may include desired outcomes. For example, the distributor may have an expectation (e.g., audience reach) from a proposed combination of the brand of the distributor, the advertiser, and the influencer. Thus, the fit server 120 may be configured to perform the functionalities described below to determine a combination that meets the expectation. In a third example, the request may include an allowed and/or banned list. This list may indicate a combination that may or may not include certain entities. For example, although a possible fit, the advertiser may not wish to associate with a certain influencer. Thus, the list included in the request may include this influencer on a banned list.

Also noted above, the ingest application 235 may transmit requests for data from the distributor system 105, the advertiser system 110, and/or the social data repository 125. That is, the ingest application 235 may require further information for functionalities of the other applications 240-270. As will be described in detail below, the ingest application 235 may transmit a request for information to utilize the other applications 240-270. For example, in determining an optimal influencer, the social data repository 125 may include data for one or more users of a social networking entity along with associated information of the users (e.g., number of followers, demographic information, topics covered by the user, etc.).

Once the ingest application 235 has received a request, an initial operation may be to determine which identities have been received. Specifically, the fit server 120 may determine whether an identity of only one of the brand of the distributor or the advertiser is received or whether both identities of the brand of the distributor and the advertiser are received in the request. If this determination indicates only a first identity, the fit server 120 may be configured to determine a second identity to be used in collaboration with the first identity. For example, if only the brand of the distributor is included in the request, an initial operation may be to determine an advertiser who may be asked to be involved in the media content campaign. In another example, if only the advertiser is included in the request, an initial operation may be to determine a brand of a distributor to which the advertiser may request to be involved in the media content campaign. As those skilled in the art will understand, any process to determine a pairing between the distributor and the advertiser may be used through affinity models. A particular brand of the distributor may be paired with one or more advertisers (or vice versa) and one of these advertisers may be selected and requested to be involved in the media content campaign. Accordingly, a preliminary step may be an agreement being reached between the distributor and the advertiser for the media content campaign.

Once the identities of the brand of the distributor and the advertiser are known, the profile application 240 may determine attributes of audiences of the distributor (e.g., associated with the distributor system 105) and audiences of the advertiser (e.g., associated with the advertiser system 110). The profile application 240 may generate a profile of the attributes based on various considerations such as a preference (via a preference engine 245), associated keywords (via a keyword engine 250), reaction toward/against (via an emotionality engine 255), and a demography (via a demography engine 260). In this manner, the profile application 240 may utilize various types of data such as social listening and emotionality data (e.g., Crimson Hexagon), talent/brand/advertiser/creator data (e.g., Tubular), talent/brand/advertiser data from a social platform (e.g., from Application Program Interfaces (APIs)), etc.

The preference engine 245 may generate a preference portion of the profile for the audience of the brand of the distributor and the audience of the advertiser. For example, for an individual brand or advertiser, the entity's audience's content category preference profile may be determined. That is, the types of content for which the audience is known to have a preference may be determined. In a particular example where the brand is a video music oriented television awards program, the content categories or affinities for the audience for such a brand may include entertainment, music, gaming, comedy, people/blogs, news/politics, howto/style, sports, and other. These content categories may be organized in a list based on a percentage of the audience who are associated with the content categories. Accordingly, the content categories/affinities for the audience of the brand may be determined on an individual basis of the brand. The preference engine 245 may further perform this operation for the advertiser.

The keyword engine 250 may generate a keyword portion of the profile for the audience of the brand of the distributor and the audience of the advertiser. For example, for an individual brand or advertiser, the keywords, topic tags, etc. tied to the audience (e.g., of other content being viewed, followed, associated, etc. by the audience) may be determined. That is, a set of keywords for content that the audience is known to view or associate may be determined. In a particular example, where the brand is again a video music oriented television awards program, the keywords of other content being viewed by the audience of the brand may include music, lifestyle, comedy, episode, food, funny, etc. These keywords may be organized graphically with keywords having an association with a greater percentage of the audience being shown corresponding larger than other keywords. Accordingly, the keywords/topic tags for the audience of the brand may be determined on an individual basis of the brand. The keyword engine 250 may further perform this operation for the advertiser.

The emotionality engine 255 may generate an emotionality portion of the profile for the audience of the brand of the distributor and the audience of the advertiser. For example, for an individual brand or advertiser, the manner in which the audience reacts toward other content may be determined. More specifically, the emotionality of the audience toward various other content may be measured and normalized into an emotion fingerprint of the audience. In a particular example, where the brand is again a video music oriented television awards program, the emotionality of the audience toward different other content may be normalized to measure reaction types toward the other content. The reaction types may include love, funny, crazy, beautiful, enjoy, happy, annoying, dislike, excited, hate, idiot, angry, etc. or any combination thereof. In a particular manner of determining the reactions, a conversation trend by members of the audience may be analyzed. These reaction types or emotions may be organized graphically with emotions having an association with a greater percentage of the audience being shown corresponding larger than other keywords. Accordingly, the emotions for the audience of the brand may be determined on an individual basis of the brand. The keyword engine 250 may further perform this operation for the advertiser.

The demography engine 260 may generate a demography portion of the profile for the audience of the brand of the distributor and the audience of the advertiser. For example, for an individual brand or advertiser, the different demographic types of the audience may be determined. The demographic types may include age, gender, location, race, etc. For each demographic type, the different percentages of the audience in a portion of the demographic type may be shown graphically (e.g., with age, the percentage of the audience in each age bracket may be shown). Accordingly, the demography for the audience of the brand may be determined on an individual basis of the brand. The keyword engine 250 may further perform this operation for the advertiser.

The profile application 240 may further perform the above described operations of the engines 245-260 to determine a profile of an influencer. In preparation for the similarity application 265, the profile of the brand of the distributor and the profile of the advertiser are determined by the profile application 240. For the similarity application 265 to subsequently determine the influencer who is proposed for a combination for a content media campaign, the profile application 240 may receive data from the social data repository 125. Again, the data from the social data repository 125 may be for a plurality of influencers (e.g., users of a social networking entity). The profile application 240 may set a minimum requirement for a user to be considered an influencer. For example, an influencer may be a user who has at least a minimum number of followers (e.g., 1 million followers). The number of followers may be determined as followers across the various social media platforms on which the user has a social identity. Operations may be performed to verify that the followers are separate individuals as a first follower on a first social networking entity and a second follower on a second social networking entity may be the same person.

As noted above, the ingest application 235 may transmit requests. Accordingly, the ingest application 235 may transmit a request to the social data repository 125 for identities of users who are influencers as well as associated information (e.g., follower information, influencer topics, etc.). For each influencer identity and based on the respective associated information, the engines 245-260 of the profile application 240 may be used to generate a profile for the audience (e.g., followers) of each influencer using a substantially similar process as described above. It is noted that, to reduce processing requirements and time, the ingest application 235 may utilize the determined profiles of the brand and the advertiser for high level traits to be considered for inclusion in the request such that an exhaustive list of influencers is not provided but a filtered list of influencers with a higher probability of being a fit for a combination.

It is noted that the system 100 may include a profile repository (not shown). The profile repository may store profiles of entities and/or audiences of the entities. For example, the profile repository may store profiles associated with audiences of brands, distributors, advertisers, and influencers. The profile repository may be populated at a variety of times. In a first example, when a request is received by the ingest application 235, the profile application 240 may perform its functionality and generate profiles for the brand, the advertiser, and the influencers which may be used for subsequent operations. The profiles being generated may be stored in the profile repository. However, those skilled in the art will understand that this process may be time consuming. Thus, in a second example, the profile repository may be populated from a monitoring and updating operation independent of any requests. The monitoring and updating operation may be performed at various times as well such as constantly, at predetermined intervals, at dynamic intervals, when an update occurring is determined, etc. The profile repository may also be updated to maintain a contemporary knowledge of influencers where influencers who become stale or whose followers drop below the minimum requirement have the profile removed, whereas new influencers meeting the minimum requirement are added. When the profile repository is available in the system 100, the profile application 240 may initially verify whether a profile for an entity already exists and retrieve the stored profile.

When the profiles of the brand, the advertiser, and the influencers are determined (or retrieved), the similarity application 265 may utilize the profiles to identify a fit of each of the influencers based on the pairing of the brand of the distributor and the advertiser. In a particular exemplary embodiment, the similarity application 265 may generate a two- or three-dimensional plot of an optimal fit space based on the pairing of the brand of the distributor and advertiser relative to the potential influencers. The similarity application 265 may utilize the profile portions for both the brand and the advertiser and the profile of the influencers to determine the likely fit from including the influencer to the pairing of the brand and the advertiser as a combination.

Based on the portion of the profile generated by the preference engine 245, the similarity application 265 may determine an overlap in the content categories or affinities of the audiences of the brand, the advertiser, and the influencers. For example, one of the influencers may be a user of a social networking entity such that the portion of the profile generated by the preference engine 245 relates to the audience of the influencer and content being viewed by the audience. The similarity application 265 may determine a raw categorization of the data for the audience (e.g., based on the content being viewed by the audience) which is exported and subsequently sorted, counted, and/or ranked across each of the content categories of the brand and the distributor. A comparison may be performed for content categories of the brand to the advertiser, of the brand to the influencers, and of the advertiser to the influencers. In this manner, an overlap of content categories between the brand, the advertiser, and the influencer may be determined.

As the breakdown of each of the content categories may be organized based on a percentage, according to a particular exemplary embodiment, the similarity application 265 may utilize a Hellinger distance to determine a similarity index of the content categories across the entities. For example, the similarity application 265 may utilize the following:

$$H ( P , Q ) = \frac{1}{\sqrt{2}} \sqrt{{\sum }_{i = 1}^{k} {( \sqrt{{p}_{i}} - \sqrt{{q}_{i}} )}^{2}}$$

The above may be used to determine a Hellingers Distance where P and Q may be vectors belonging to a n-dimensional real vector space describing a discrete probability distribution. There may be a few constraints on the elements of P and Q such that a sum of all elements equal 1. The variables p and q may be individual elements of the vector. The similarity application 265 may then return a cross-referenced matching such as in a table or a pie chart. The content categories of the first entity (e.g., brand) may be listed in percentage order (e.g., from highest to lowest). The similarity application 265 may highlight select ones of the content categories that overlap with the other entities along with presenting the corresponding percentage for the audience of the first entity. The table may also include a substantially similar listing and highlighting for the second entity (e.g., advertiser) and the third entity (e.g., influencer). The similarity application 265 may generate further tables for further influencers when the brand and the advertiser are used to identify the influencer.

Based on the portion of the profile generated by the keyword engine 250, the similarity application 265 may determine an overlap of commonly used keywords or topic tags tied to the brand, the advertiser, and the influencers. For example, one of the influencers may be a user of a social networking entity such that the portion of the profile generated by the keyword engine 250 relates to the audience of the influencer and content being viewed by the audience. The similarity application 265 may determine a raw topic tag data for the audience (e.g., based on the content being viewed by the audience) which is exported and subsequently aggregated, sorted, counted, and/or ranked across each of the keywords of the brand and the distributor.

As the breakdown of each of the keywords may be organized based on a percentage, according to a particular exemplary embodiment, the similarity application 265 may utilize a tagging, clustering, and indexing operation to determine how the keywords are associated across the entities. For example, the similarity application 265 may utilize the following:

$$d ( X , Y ) = 1 - \frac{\vert X {⋂}_{N} Y \vert}{\vert X {⋃}_{N} Y \vert}$$

The above may be used for a Jaccard index to build a similarity metric between entities. Specifically, a distance may be defined as a ratio of the common elements in set X and the total number of unique elements in set X and Y. The similarity application 265 may then return a list of the keywords such as in a bubble chart or a word cloud. The keywords of the first entity (e.g., brand) may be shown in varying sized bubbles (e.g., highest association having a largest bubble). The bubble chart/word cloud may also include a substantially similar graphical representation for the second entity (e.g., advertiser) and the third entity (e.g., influencer). In this manner, patterns or common keywords may be easily identified. The similarity application 265 may generate further bubble charts/word clouds for further influencers when the brand and the advertiser are used to identify the influencer.

Based on the portion of the profile generated by the emotionality engine 255, the similarity application 265 may determine an overlap tied to reactions of audiences of the brand, the advertiser, and the influencers. For example, one of the influencers may be a user of a social networking entity such that the portion of the profile generated by the emotionality engine 255 relates to how the audience reacts to the content of the influencer. The similarity application 265 may combine the reactions to generate an emotionality factor fit criterion. According to a particular exemplary embodiment, the similarity application 265 may utilize an emotion taxonomy and merging with emotion fingerprints to determine an emotion index. For example, the similarity application 265 may utilize the following:

$${D}_{KL} ( P \vert \vert Q ) = {\sum }_{i} P ( i ) ln \frac{P ( i )}{Q ( i )}$$

The above may be used as a Kullback-Leibler (KL) divergence to calculate a similarity between probability distributions. The KL divergence may not be required to obey a triangle inequality as the KL divergence is not symmetric (e.g., like the Hellinger distance) but may be easier to use for comparing distributions whose upper bound on number of possible elements is unknowable or infinite (e.g., some features like free form topic tags and emotional fingerprints have an unbounded number of possible values and are thus not countable in a mathematical sense). The variables P and Q may be multi-dimensional vectors which represent a probability distribution. The similarity application 265 may then return a list of the emotions such as in a box table. The emotions of the audience toward content of the first entity (e.g., brand) may be shown in varying sized boxes (e.g., highest association having a largest box). The box table may also include a substantially similar graphical representation for the second entity (e.g., advertiser) and the third entity (e.g., influencer). In this manner, patterns or common reactions may be easily identified. The similarity application 265 may generate further box tables for further influencers when the brand and the advertiser are used to identify the influencer.

Based on the portion of the profile generated by the demography engine 260, the similarity application 265 may determine an overlap in demographics of the audiences of the brand, the advertiser, and the influencers. For example, one of the influencers may be a user of a social networking entity such that the portion of the profile generated by the preference engine 245 relates to the audience of the influencer and how different demographic types are associated with the audience. The similarity application 265 may determine a demographic distribution and determine a demographic fit criterion. According to a particular exemplary embodiment, the similarity application 265 may utilize an interpolation, a kernel density estimation of the demographics, and normalized fingerprints to determine a demographic index. For example, the similarity application 265 may utilize the following:

$${D}_{KL} ( P \vert \vert Q ) = {\int }_{- ∞}^{∞} p ( x ) log \frac{p ( x )}{q ( x )} dx$$

As those skilled in the art will understand, bucketing of demographics is gross in its granularity due to the traditional use of small amounts of data. However, this granularity and the bucketing system itself may be different across vendors. For example, age, sex, and ethnicity are a few of the demographic features that have been traditionally used. Given the lack of standardization of the bucketing system, kernel density estimation is used to take a discrete probability distribution and convert it into a continuous one which may then be used to infer an approximate volume of an audience expected in a bucket that may not have existed in the other bucketing systems. Accordingly, the above may reasonably assume that a true probability distribution is smooth and does not have jump discontinuities. The variables p and q may represent the vectors for probability distributions and exist in a high dimensional real vector space. The obtained results for each feature using this process may then be used to generate a global distance score of how far an entity's feature's distribution is from another entity. This specific weight associated with each feature may take into account either on the preference of the entity based on domain knowledge or learned from prior examples with known actual performance using traditional machine learning techniques. The similarity application 265 may then return a list of the demographics such as in a side-by-side-by-side bar chart of the demographics. The demographics of the audience of the first entity (e.g., brand), the second entity (e.g., advertiser), and the third entity (e.g., influencer) may be shown collectively for each portion of the demographic type. For example, in an age bracket for an age demographic, a first bar may illustrate the percentage of the audience of the first entity, a second bar may illustrate a percentage of the audience of the second entity, and a third bar may illustrate a percentage of the audience of the third entity. In this manner, patterns may be easily identified. The similarity application 265 may generate further bar charts for further influencers when the brand and the advertiser are used to identify the influencer.

It is noted that the above operations and the engines 245-260 are only exemplary. The profile application 240 may be configured to utilize different engines and/or further engines in determining how individual strengths and characteristics of a first entity may be tied to strengths/characteristics of a second entity as well as a third entity. With more similarities and comparisons being available, the similarity application 265 may determine a combination of brand, advertiser, and influencer having a highest probability of success in a media content campaign. In fact, further engines may enable and even more granular window into this universe of entities.

Once the similarity application 265 has determined the various comparisons and the distance and similarity metrics are generated for the pairing of the brand and the advertiser with each of the influencers, the similarity application 265 may rank the influencers with an overall score. Thus, given the brand and the advertiser, the influencers may be ranked according to the overall score. An influencer with a highest score may represent a social networking user having a follower base and having strengths/characteristics that match or fit the strengths/characteristics associated with both the brand and the advertiser. In this manner, the requesting entity (e.g., the distributor) may receive the list of influencers and select one of these influencers to join the media content campaign.

The similarity application 265 may also be configured to determine how the combination of the brand, the advertiser, and a selected influencer is expected to perform for the media content campaign. For example, there may be projections of how many people the combination will reach over one or more social networking entities in which the influencer may have followers.

As described above, the output application 270 may generate graphical representations of the various outputs from the profile application 240 and the similarity application 265. Specifically, the output application 270 may export the results and/or visualizations for reports in, for example, a custom user interface. The output application 270 may first generate a graphical representation of the list of highest ranked influencers (or an exhaustive list) and transmit the graphical representation to the requesting entity. The output application 270 may also generate a graphical representation of the projections and transmit this graphical representation to the requesting entity.

The output application 270 may also generate visualizations and/or graphical representations for the results generated by the engines 245-260 and/or the similarity application 265. As described above, various pie charts, bubble charts, word clouds, box charts, or bar charts may be generated for each portion of the profile generated by the engines 245-260. If a request is received for other determinations beyond the list of ranked influencers, the output application 270 may also generate the corresponding graphical representation and transmit this to the requesting entity.

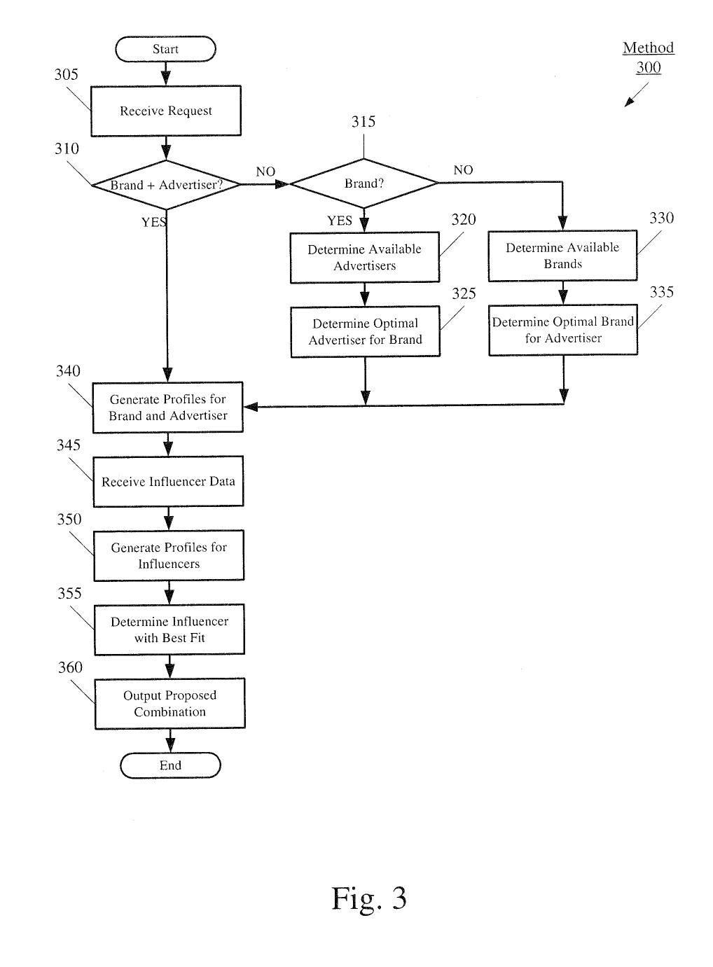

FIG. 3 shows a method of determining a social fit across a plurality of entities according to the exemplary embodiments. The method 300 relates to the process by which the fit server 120 receives a request to determine a combination of a brand, an advertiser, and an influencer and provides a list of ranked influencers to be used with a brand/advertiser pairing. The method 300 will be described from a perspective of the fit server 120. The method 300 will be described with regard to the system 100 of FIG. 1 and the fit server 120 of FIG. 2.

In 305, the fit server 120 receives a request from an entity or pair of entities. As described above, the request may be from a distributor (of a brand), an advertiser, or a pairing of the distributor and the advertiser. The request may include an identity or identities of the entities. The request may also include other information such as parameters by which a response from the fit server 120 is to consider in determining the combination for the media content campaign.

In 310, the fit server 120 determines whether the request includes the identity of both the brand and the advertiser or only one of the brand/advertiser. If both the brand and the advertiser are identified in the request, the fit server 120 continues to 340. However, if only one of the identities are included in the request, the fit server 120 continues to 315.

In 315, the fit server 120 determines whether the identity of the brand has been included. If the brand has been included, in 320, the fit server 120 determines available advertisers who may be involved in a media content campaign for the brand of the distributor. In 325, the fit server 120 determines an optimal advertiser for the brand. If the advertiser has been included, in 330, the fit server 120 determines available brands or distributors who may be launching a media content campaign to which the advertiser may be involved. In 335, the fit server 120 determines an optimal brand for the advertiser. It is noted that the fit server 120 including this functionality is only exemplary. In another exemplary embodiment, 315-335 may be performed by another service for the pairing of the brand and advertiser to be determined.

In 340, the fit server 120 may generate profiles for the brand and the advertiser. As described above, various characteristics may be used in generating the profiles for the brand and the advertiser. For example, the characteristics may include preferences/affinities for content of an audience of the entity, keywords associated with content viewed by an audience of the entity, emotionality of the audience toward an entity, and demography of the audience of an entity. In combining these various characteristics, the fit server 120 may generate a profile for each entity. It is again noted that if a pre-existing profile for the entities already exist, the profile may be retrieved (and updated if necessary).

In 345, the fit server 120 requests and receives data of influencers from the social data repository 125. As the combination for the media content campaign involves the brand, the advertiser, and an influencer, the available influencers are identified and data thereof is requested and received. The influencers may be any user in the social networking universe with a minimum number of followers. It is noted that the use of a minimum number of followers is only exemplary and the exemplary embodiments may also consider a minimum reach (e.g., views, impressions, etc.) or a combination thereof. The data of the influencers may include an identity of the influencer and information regarding the audience or followers of the influencer.

In 350, the fit server 120 may generate profiles for the influencers identified in the data received from the social data repository 125. The profiles of the influencers may also be generated based on various characteristics used in generating the profiles of the brand and the advertiser.

In 355, the fit server 120 determines which of the influencers is a best fit for the pairing of the brand and the advertiser. Using various comparisons and analyses of the different aspects of the profiles, the fit server 120 may determine how well an influencer fits with a pairing of the brand and the advertiser. In this manner, an overall score may be generated for each influencer.

In 360, the fit server 120 transmits a proposed combination from the influencers determined to have a fit with the pairing of the brand and the advertiser. As described above, the fit server 120 may output the proposed combination with various graphical representations as well as the outputs for the portions of the profiles.

The exemplary embodiments provide a device, system, and method for determining a combination social fit assessment between three or more entities. Based on at least one entity identity, the exemplary embodiments may determine a pairing of a first entity with a second entity and subsequently determine a third entity to be involved in a media content campaign. Through incorporation of various comparisons, analyses, and similarity metrics, the exemplary embodiments are configured to determine the third entity that considers characteristics of both the first entity and the second entity as well as how those characteristics are tied between the first and second entities. By utilizing an optimal combination of the three entities, a mutually beneficial cooperative venture may be launched for the media content campaign. For example, the first entity may be a distributor of a brand who receives financing from the second entity as well as reaching a larger audience due to the involvement of the third entity. The second entity may be an advertiser who sponsors the media content and receives a greater advertising range for a product. The third entity may be an influencer or social networking personality who reaches a greater audience and/or receives financial compensation.

It is noted that as the granularity, richness, and depth of available third-party social data increases, the exemplary embodiments may be appropriate modified to utilize updated available data. The exemplary embodiments may thereby provide the above described features in a meaningfully efficient manner and the actual calculation (e.g., after the data has been cleaned, munged, and formatted) may be performed in a computationally efficient procedure.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system such as Microsoft Windows, a Mac platform and MAC OS, a mobile device having an operating system such as iOS or Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
in a fit server:
receiving a request including an identity of a first entity and an identity of a second entity, the first and second entities cooperatively involved in a collaborative campaign;
generating a first profile for the first entity and a second profile for the second entity, the first and second profiles being generated based on characteristic types of a first audience associated with the first entity and a second audience associated with the second entity, respectively;
determining at least one third entity to be cooperatively involved in the collaborative campaign;
generating a respective third profile for each of the at least one third entity, the third profile being generated based on the characteristic types of a third audience associated with the third entity;
determining a respective similarity index for each of the at least one third entity with the first and second entities based on the first, second, and third profiles; and
determining at least one of the at least one third entity to be involved in the collaborative campaign based on the similarity index.

2. The method of claim 1, wherein the first entity is a distributor for a brand, the second entity is an advertiser, and the third entity is an influencer.

3. The method of claim 2, wherein the influencer has a predetermined minimum number of followers in the third audience.

4. The method of claim 1, wherein the characteristic types include a preference portion, a keyword portion, an emotionality portion, and a demography portion, wherein the preference portion identifies content categories associated with the first, second, and third audiences, wherein the keyword portion identifies keywords of content being viewed by the first, second, and third audiences, wherein the emotionality portion indicates reaction types toward of the first, second, and third audiences toward the first, second, and third entities, respectively, and wherein the demography portion identifies demographics of the first, second, and third audiences.

5. The method of claim 1, further comprising:
generating an output that includes the at least one of the at least one third entity; and
transmitting the output to at least one of the first entity or the second entity that transmitted the request.

6. The method of claim 5, wherein the at least one of the at least one third entity includes a plurality of third entities, the output including a ranked list of the third entities based on a respective similarity index.

7. The method of claim 5, wherein the output includes at least one projection for a select one of the at least one of the at least one third entity, the at least one projection being associated with a reach to the third audience.

8. The method of claim 7, wherein the third audience is a cumulative audience across at least one social networking entity in which the third entity is associated.

9. The method of claim 5, further comprising:
performing a respective comparison analysis for each of the characteristic types; and
generating a respective graphical representation for each of the comparison analyses.

10. The method of claim 9, wherein the output includes each of the graphical representations.

11. The method of claim 9, wherein the graphical representation is one of a pie chart, a table, a bubble chart, a word cloud, a box chart, or a bar chart.

10. The method of claim 1, further comprising:
receiving a prior request including an identity of one of the first entity and the second entity; and
determining an identity of the other one of the first entity and the second entity, the determining being based on affinity models, the request to include the identity for the first and second entities.

12. The method of claim 1, wherein the collaborative campaign is a media content campaign.

13. A fit server, comprising:
a transceiver receiving a request including an identity of a first entity and an identity of a second entity, the first and second entities cooperatively involved in a collaborative campaign; and
a processor generating a first profile for the first entity and a second profile for the second entity, the first and second profiles being generated based on characteristic types of a first audience associated with the first entity and a second audience associated with the second entity, respectively, the processor determining at least one third entity to be cooperatively involved in the collaborative campaign, the processor generating a respective third profile for each of the at least one third entity, the third profile being generated based on the characteristic types of a third audience associated with the third entity, the processor determining a respective similarity index for each of the at least one third entity with the first and second entities based on the first, second, and third profiles, the processor determining at least one of the at least one third entity to be involved in the collaborative campaign based on the similarity index.

14. The fit server of claim 13, wherein the first entity is a distributor for a brand, the second entity is an advertiser, and the third entity is an influencer.

15. The fit server of claim 14, wherein the influencer has a predetermined minimum number of followers in the third audience.

16. The fit server of claim 13, wherein the characteristic types include a preference portion, a keyword portion, an emotionality portion, and a demography portion, wherein the preference portion identifies content categories associated with the first, second, and third audiences, wherein the keyword portion identifies keywords of content being viewed by the first, second, and third audiences, wherein the emotionality portion indicates reaction types toward of the first, second, and third audiences toward the first, second, and third entities, respectively, and wherein the demography portion identifies demographics of the first, second, and third audiences.

17. The fit server of claim 13, wherein the transceiver further receives a prior request including an identity of one of the first entity and the second entity, and wherein the processor further determines an identity of the other one of the first entity and the second entity, the determining being based on affinity models, the request to include the identity for the first and second entities.

18. The fit server of claim 13, wherein the processor further performs a respective comparison analysis for each of the characteristic types and generates a respective graphical representation for each of the comparison analyses.

19. The fit server of claim 18, wherein the graphical representation is one of a pie chart, a table, a bubble chart, a word cloud, a box chart, or a bar chart.

20. A method, comprising:
in a fit server:
receiving a request including an identity of a first entity and an identity of a second entity, the first and second entities cooperatively involved in a collaborative campaign;
generating a first profile for the first entity and a second profile for the second entity, the first and second profiles being generated based on characteristic types of a first audience associated with the first entity and a second audience associated with the second entity, respectively;
determining an overlap in the first and second profiles for the characteristic types between the first and second entities;
determining at least one third entity to be cooperatively involved in the collaborative campaign, the at least one third entity including the overlap in the first and second profiles;
generating a respective third profile for each of the at least one third entity, the third profile being generated based on the characteristic types of a third audience associated with the third entity;
determining a respective similarity index for each of the at least one third entity with the first and second entities based on the first, second, and third profiles; and
determining at least one of the at least one third entity to be involved in the collaborative campaign based on the similarity index.
